(19) United States
(12) Patent Application Publication
(10) Pub. No.: US 2019/0206006 A1
(43) Pub. Date: Jul. 4, 2019

(54) LOGISTICS DATA TRANSMITTING SYSTEM AND METHOD THEREOF

(71) Applicant: Goldtek Technology Co., Ltd., New Taipei City (TW)

(72) Inventor: JUI-CHI LEE, New Taipei (TW)

(21) Appl. No.: 15/943,833

(22) Filed: Apr. 3, 2018

(30) Foreign Application Priority Data
Jan. 4, 2018 (TW) 107100399

(51) Int. Cl. G06Q 50/28; G06F 17/30

(52) U.S. Cl. CPC G06Q 50/28; G06F 17/30522; G06F 17/30569; G06F 17/30371

(57) ABSTRACT

The present disclosure provides a logistics data transmitting system for receiving and transmitting logistics data. The logistics data transmitting system comprises at least one end device, a local management device, and a central server. The at least one end device receives logistics data and transmits the logistics data to the local management device. The local management device processes the logistics data transmitted from the end device, and transmits the processed logistics data to the central server. The local management device comprises a collecting unit, a combining unit and a processed data storage unit. The collecting unit determines whether the logistics data satisfies a checking rule. The combining unit structures the logistics data and combines the structured logistics data to form a data group. The processed data storage unit stores the data group.

### CROSS-REFERENCE TO RELATED APPLICATIONS

This application claims priority to Taiwanese Invention Patent Application No. 107100399 filed on Jan. 4, 2018, the contents of which are incorporated by reference herein.

### FIELD

The present disclosure generally relates to a logistics data transmitting system and method thereof. More particularly, the present disclosure relates to a logistics data transmitting system that uses a local management device to process the logistics data.

### BACKGROUND

Currently, E-commence allows people to buy or sell items online instead of going to a store. The development of E-commence largely increases the quantity of logistics data to push logistics service providers to use intelligent devices to transmit logistics data. Usually, a logistics personal uses a handhold end device to scan or manually input logistics data. Then, the logistics data is transmitted to a central server by the handhold end device to be processed for other operations. The logistics data transmitted from the end devices must be verified and structured by the central server for the purposes of management. The increasing quantity of logistics data causes an overloading to the central server.

Therefore, there is a need to provide a more efficient way to transmit the logistics data.

### SUMMARY

In view of above, the object of the present disclosure is to provide a logistics data transmitting system and method thereof. The logistics data transmitting system uses a local management device to receive the logistics data from end devices. The local management device also checks and structures the logistics data. The local management device combines the structured logistics data to form a data group, and transmits the data group to the central server. Accordingly, the logistics data from end devices can be pre-processed at the local management device; and the processing loading of the central server can be reduced. Therefore, the efficiency of logistics data transmission can be improved.

To achieve the above object, the present disclosure provides a logistics data transmitting system for receiving and transmitting logistics data. The logistics data transmitting system comprises at least one end device, a local management device, and a central server. The at least one end device receives logistics data and transmits the logistics data to the local management device. The local management device processes the logistics data transmitted from the end device, and transmits the processed logistics data to the central server. The local management device comprises a collecting unit, a combining unit, and a processed data storage unit. The collecting unit determines whether the logistics data satisfies a checking rule. The combining unit structures the logistics data and combines the structured logistics data to form a data group. The processed data storage unit stores the data group.

To achieve the above object, the present disclosure also provides a logistics data transmitting method for a logistics data transmitting system. The logistics data transmitting system comprises at least one end device, a local management device, and a central server. The logistics data transmitting method comprises below steps. The local management device receives logistics data from the end device. The collecting unit determines whether the logistics data satisfies a checking rule. The combining unit structures the logistics data and stores the structured logistics data in the processed data storage unit. The local management device determines whether the logistics data in the processed data storage unit exceeds a predetermined quantity. When the logistics data in the processed data storage unit exceeds the predetermined quantity, the local management device combines the logistics in the processed data storage unit to form a data group. The local management device transmits the data group to the central server.

As described above, the logistics data transmitting system of the present disclosure uses a local management device to receive the logistics data from end devices. The local management device also checks and structures the logistics data. The local management device combines the structured logistics data to form a data group, and transmits the data group to the central server. Accordingly, the logistics data from end devices can be pre-processed at the local management device; and the processing loading of the central server can be reduced. Therefore, the efficiency of logistics data transmission can be improved. Additionally, the logistics data transmitting system can be easily expanded by adding new local management devices as a sub-system. Therefore, the logistics data transmitting system allows a logistics service provider to arrange the architecture of the logistics system for different requirements. A new local management can be added to the system as a sub-system without changing the original architecture. Also, the logistics data transmitting system of the present disclosure structures raw logistics data to form a structured data group to solve the discontinuity problem of data from different end devices at different time, and hence improves the readability of the logistics data.

### BRIEF DESCRIPTION OF THE DRAWINGS

Implementations of the present technology will now be described, by way of example only, with reference to the attached figures.

FIG. 1 is a schematic diagram of a logistics data transmitting system according to a preferred exemplary embodiment of the present disclosure.

FIG. 2 is a hardware block diagram of a local management device according to the preferred exemplary embodiment of the present disclosure.

FIG. 3 is a functional block diagram of a local management device according to the preferred exemplary embodiment of the present disclosure.

FIG. 4 is a schematic diagram showing the data transmission of the logistics data transmitting method according to the preferred exemplary embodiment of the present disclosure.

FIG. 5 is a flowchart of a logistics data transmitting method according to a preferred exemplary embodiment of the present disclosure.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

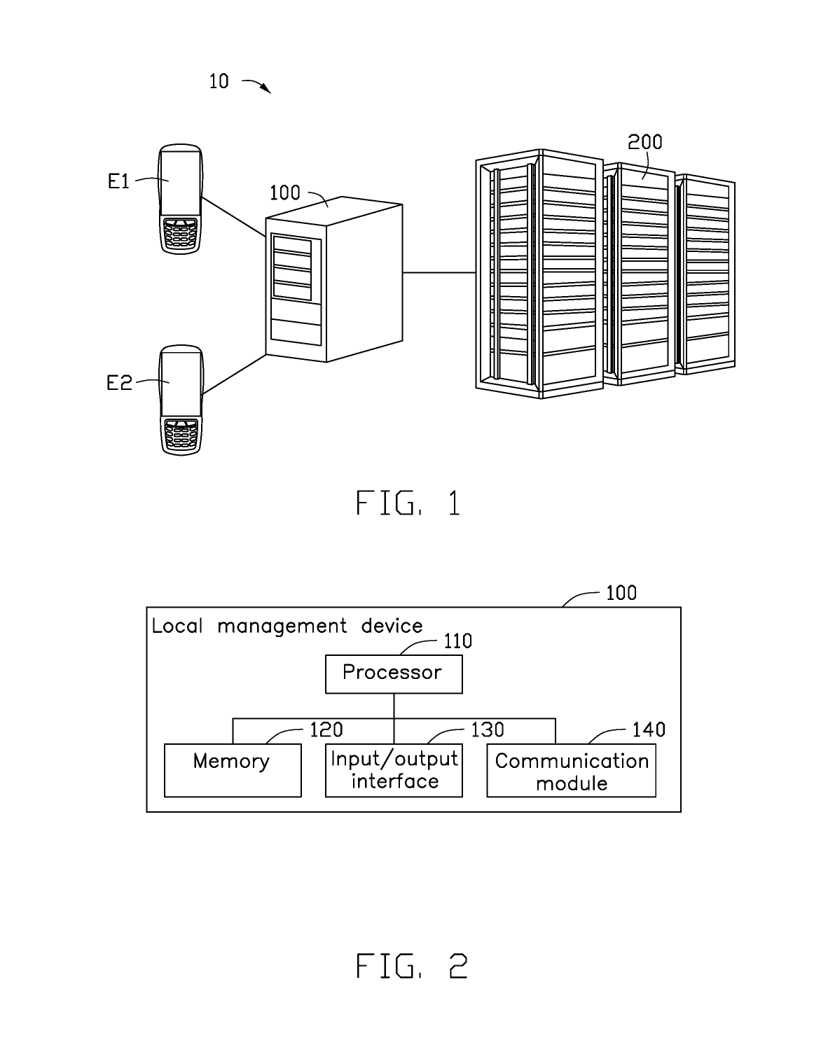

The description will be made as to the exemplary embodiments of the present disclosure in conjunction with the accompanying drawings in FIGS. 1 to 5. Reference will be made to the drawing figures to describe the present disclosure in detail, wherein depicted elements are not necessarily shown to scale and wherein like or similar elements are designated by same or similar reference numeral through the several views and same or similar terminology.

The present disclosure will be further described hereafter in combination with figures.

Referring to FIG. 1, a schematic diagram of a logistics data transmitting system according to a preferred exemplary embodiment of the present disclosure is illustrated. As shown in FIG. 1, the logistics data transmitting system 10 for receiving and transmitting logistics data comprises at least one end device E1 or E2, a local management device 100, and a central server 200. The at least one end device E1 or E2 receives the logistics data and transmits the logistics data to the local management device 100. The at least one end device E1 or E2 can be a handhold logistics electronic device used by a logistics personnel. The end device E1 or E2 may comprises a bar code scanning module (not shown in the figures) to obtain logistics data, such as sending location, receiving location, and goods description. Additionally, the end device E1 or E2 may further comprises a user interface (not shown in the figures). The logistics personnel can use the user interface to manually input the logistics data. The end device E1 or E2 may also comprises a wireless module (not shown in the figures) to wirelessly transmit the logistics data to the local management device 100. The component and function of the end device E1 or E2 are conventional without further description. Using the end device E1 as an example, the logistics personnel uses the end device E1 to obtain logistics data by the bar code scanning module. The logistics data is transmitted to the local management device 100 by the wireless module. The local management device 100 processes the logistics data transmitted from the end device E1 or E2 and transmits the processed logistics data to the central server 200. The local management device 100 can be a local server, which is located at a local service office or other assigned places defined by a logistics service provider. The local management device 100 receives the logistics data transmitted from the end devices within a predetermined range. The local management device 100 collects and structures the logistics data. The processed logistics data is transmitted to the central server 200 for other operations. The central server 200 can receive the processed logistics data transmitted from the local management devices 100 of different regions. In other words, one central server 200 receives the logistics data from a plurality of local management devices 100; and one local management device 100 receives the logistics data from a plurality of end devices E1 and E2. Accordingly, a network for logistics data transmission can be form. Additionally, the local management 100 of the present disclosure can pre-process the logistics data transmitted from the end device E1 and E2 before transmitting to the central server 200. Therefore, the processing loading of the central server can be reduced; and the efficiency of logistics data transmission can be improved.

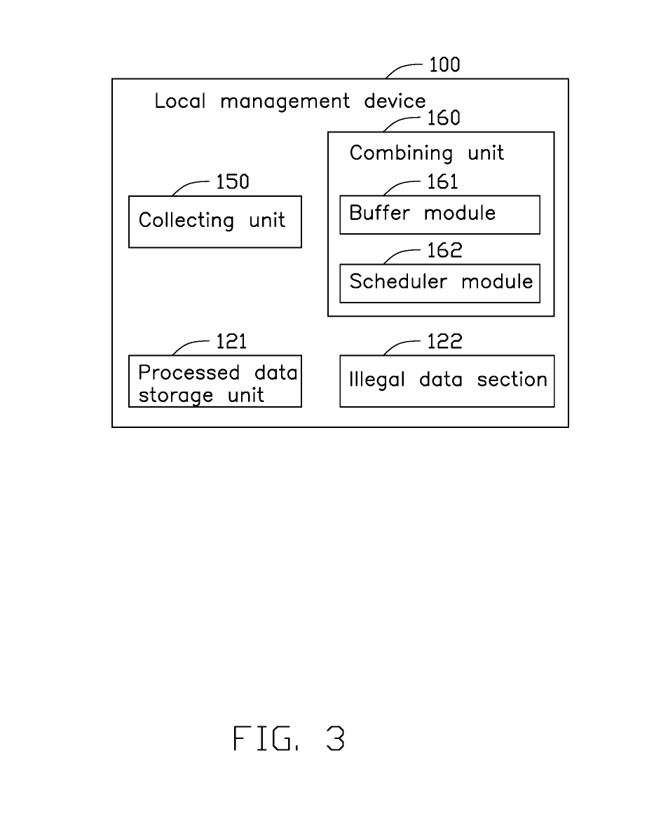

Referring to FIG. 2, a hardware block diagram of the local management device 100 according to the preferred exemplary embodiment of the present disclosure is illustrated. As shown in FIG. 2, the local management device 100 of the present disclosure comprises a processor 110, a memory 120, an input/output interface 130 and a communication module 140. The processor 110 processes the logistics data. The processor 110 connects to and controls the memory 120, the input/output interface 130 and the communication module 140. The memory 120 stores the logistics data. The input/output interface 130 inputs and outputs the logistics data. The communication module 140 transmits the logistics data. As described above, the local management device 100 can be a local server, which is located at a local service office or other assigned places defined by a logistics service provider. The local management device 100 receives the logistics data transmitted from the end devices within a predetermined range. The local management 100 of the present disclosure can pre-process the logistics data transmitted from the end device E1 and E2 before transmitting to the central server 200. Therefore, the processing loading of the central server can be reduced. The hardware shown in FIG. 2 can be any form of electronic devices for different using environments or different platforms, not limited to the exemplary embodiment of FIG. 2.

Referring to FIG. 3, a functional block diagram of the local management device 100 according to the preferred exemplary embodiment of the present disclosure is illustrated. As shown in FIG. 3, the local management device 100 comprises a collecting unit 150, a combining unit 160, and a processed data storage unit 121. The local management device further comprises an illegal data section 122. The collecting unit 150 collects the logistics data, and determines whether the logistics data satisfies a checking rule. The checking rule is predefined by the logistics service provider. The collecting unit 150 collects the logistics data from connected devices (such as the end devices E1 and E2), software or other data sources. Meanwhile, the collecting unit 150 controls a flow rate of the logistics data. After collecting the logistics data, the collecting unit 150 determines whether the logistics data is correct by the checking rule, and filters incorrect logistics data. If the logistics data is incorrect (i.e. the logistics data does not satisfy the checking rule), the incorrect logistics data is discarded or transmitted to the illegal data section 122. The incorrect logistics data is temporarily stored in the illegal data section 122 and discarded periodically. The logistics data that satisfies the checking rule is arranged in order and classified by the collecting unit 150, and then transmitted to the combining unit 160. The logistics data can be sorted by time or by size. The collecting unit 150 classifies the logistics data by type. The combining unit 160 further comprises a buffer module 161 and a scheduler module 162. In the buffer module 161, the logistics data is converted into an event by algorithms according to different end devices. The buffer module 161 comprises specific event checking rules. Each specific event is added with a weighted index. An emergent event will be immediately transmitted to the scheduler module 162 to be scheduled to transmit to the central server 200 as soon as possible. The event can be received from multiple data sources. When there is a blocking or a time gap, the buffer module 161 can structure single events to form a data group to prevent the events from disorder or missing. The data group is stored in the processed data storage unit 121, and then scheduled by the scheduler module 162 to transmit to the central server 200. Before sending to the central server 200, all the data groups are stored in the processed data storage unit 121. The scheduler module 162 checks the quantity of events stored in the processed data storage unit 121. When the quantity of the events reaches a predetermined value, the data group is transmitted to the central server 200 by the scheduler module 162. The data group is transmitted by the rules for different size, priority, and bandwidth of the network. When an abnormality is occurred during the transmission, the scheduler module 162 resends the data group. When the transmission is done, the scheduler module 162 cleans the data group that has been transmitted to the central server 200 to prevent the problem of discontinuity.

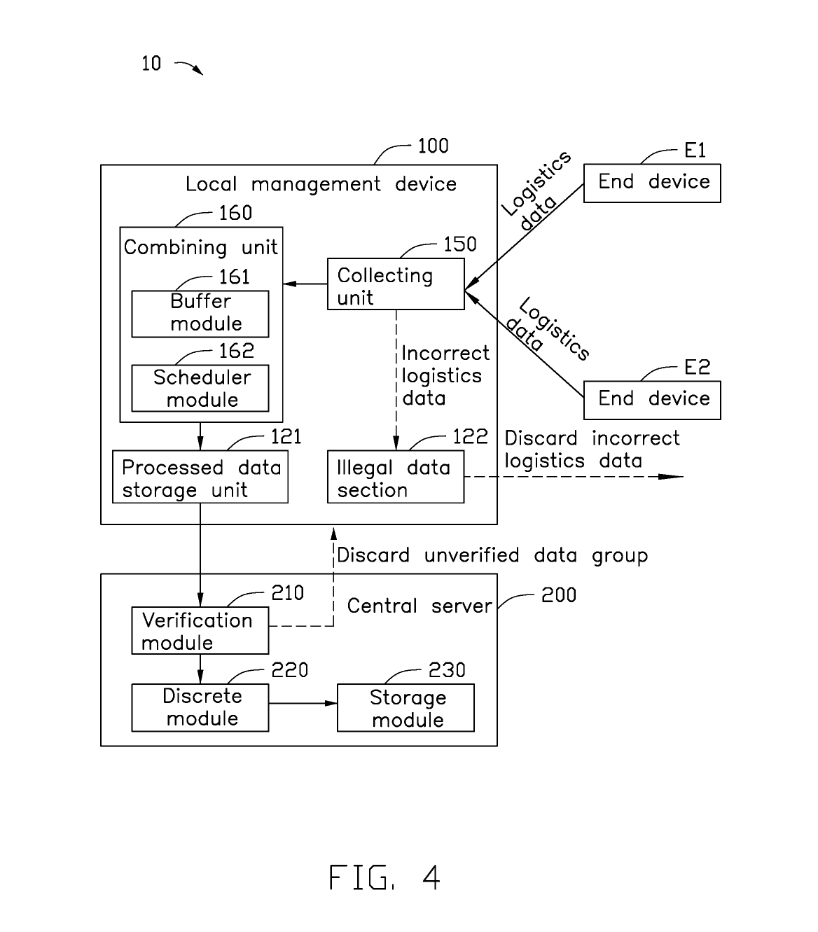

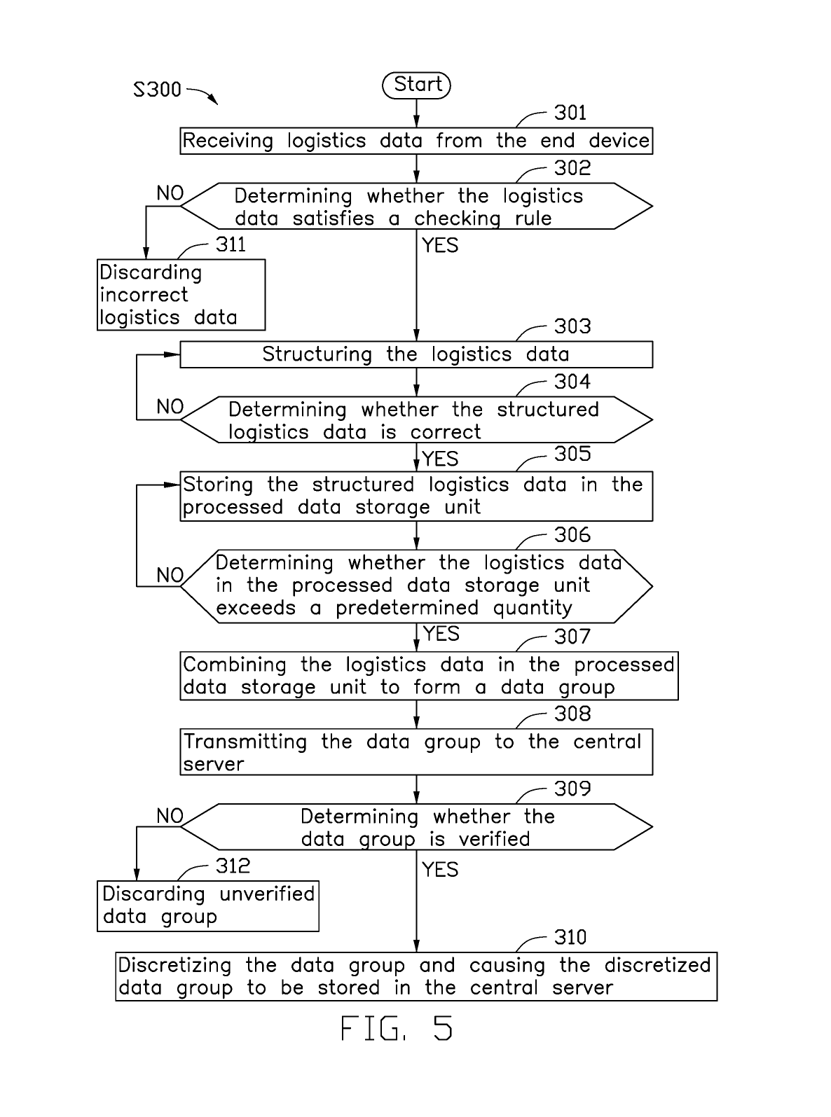

Referring to FIG. 4, a schematic diagram showing the data transmission of the logistics data transmitting method according to the preferred exemplary embodiment of the present disclosure is illustrated. After the local management device 100 receives the logistics data from the end devices E1 and E2, the logistics data is firstly transmitted to the collecting unit 150. The collecting unit 150 determines whether the logistics data satisfies the checking rule. When the logistics data does not satisfy the checking rule, the incorrect logistics data is transmitted to the illegal data section and discarded periodically. The logistics data that satisfies the checking rule is arranged in order and classified by the collecting unit, and then transmitted to the combining unit 160. The combining unit 160 further comprises a buffer module 161 and a scheduler module 162. In the buffer module 161, the logistics data is converted into an event by algorithms according to different end devices. The buffer module 161 comprises specific event checking rules. A weighted index is added to each specific event. An emergent event will be immediately transmitted to the scheduler module 162 to be scheduled to transmit to the central server 200 as soon as possible. The event can be received from multiple data sources. When there is a clogging or a time gap, the buffer module 161 can structure single events to form a data group to prevent the events from disorder or missing. The data group is stored in the processed data storage unit 121, and then scheduled by the scheduler module 162 to transmit to the central server 200. Before sending to the central server 200, all the data groups are stored in the processed data storage unit 121. The scheduler module 162 checks the quantity of events stored in the processed data storage unit 121. When the quantity of the events reaches a predetermined value, the data group is transmitted to the central server 200 by the scheduler module 162. The data group is transmitted by the rules for different size, priority, and bandwidth of the network. When an abnormality is occurred during the transmission, the scheduler module 162 resends the data group. When the transmission is done, the scheduler module 162 cleans the data group that has been transmitted to the central server 200 to prevent the problem of discontinuity.

The central server 200 comprises a verification module 210, a discrete module 220 and a storage module 230. The verification module 210 determines whether the data group is verified. The verification module 210 stops unverified data group from communicating with the data stored in the central server 200, and therefore secures the data stored in the central server 200. If the data group is not verified, the verification module 210 directly discards the unverified data group. If the data group is verified, the verified data group is then transmitted to the discrete module 220. The discrete module 220 discretizes the data group to become a discrete logistics data. The discrete logistics data is then converted to a continuous logistics data. The continuous logistics data is stored in the storage module 230. The logistics data stored in the storage module 230 can be accessed by an authorized user for other operations.

Referring to FIG. 5, a flowchart of a logistics data transmitting method according to a preferred exemplary embodiment of the present disclosure is illustrated. The logistics data transmitting method S300 of the present disclosure is applicable for the logistics data transmitting system 10 shown in FIG. 4. As shown in FIG. 4, the logistics data transmitting system 10 comprises at least one end device E1 and E2, a local management device 100 and a central server 200. The local management device 100 comprises a collecting unit 150, a combining unit 160 and a processed data storage unit 121. The details of the logistics data transmitting system 10 can be referred to above description. The logistics data transmitting method S300 comprises steps S301 to S312.

In step S301, the local management device 100 receives logistics data from the end device E1 or E2. In step S302, the collecting unit 150 determines whether the logistics data satisfies a checking rule. If the determination in step S302 is NO, the method S300 proceeds to step S311. In step S311, the incorrect logistics data is discarded. Alternatively, as shown in FIG. 4, the incorrect logistics data is stored in an illegal data section 122 and discarded periodically. If the determination in step S302 is YES, the method S300 proceeds to step S303. In step S303, the combining unit 160 structures the logistics data. In step S304, the combining unit 160 determines whether the structured logistics data is correct. If the determination in step S304 is NO, the method S300 returns to step S303 for restructuring. If the determination in step S304 is YES, the method S300 proceeds to step S305. In step S305, the combining unit 160 stores the structured logistics data in the processed data storage unit 121. In step S306, the local management device 100 determines whether the logistics data in the processed data storage unit 121 exceeds a predetermined quantity. If the determination in step S306 is NO, the method S300 returns to step S305 to continue to store the structured logistics data in the processed data storage unit 121. If the determination in step S306 is YES, the method S300 proceeds to step S307. In step S307, when the logistics data in the processed data storage unit 121 exceeds the predetermined quantity, the local management device 100 combines the logistics data in the processed data storage unit 121 to form a data group. In step S308, the local management device 100 transmits the data group to the central server 200. The data group is transmitted by the rules for different size, priority, and bandwidth of the network.

The central server 200 comprises a verification module 210, a discrete module 220 and a storage module 230. When the data group is transmitted to the central server 200, in step S309, the verification module 210 determines whether the data group is verified. If the determination in step S309 is NO, the central server 200 directly discards the unverified data group. Or, the unverified data group can be temporarily stored in the central server 200 and then discarded periodically. If the determination in step S309 is YES, the method 300 proceeds step S310. In step S310, the discrete module 220 discretizes the data group and causes the discretized data group to be stored in the storage module 230 of the central server 200. The discrete module 220 discretizes the data group to create a discrete logistics data. The discrete logistics data is then converted to continuous logistics data. The continuous logistics data is stored in the storage module 230. The logistics data stored in the storage module 230 can be accessed by an authorized user for other operations.

As described above, the logistics data transmitting system of the present disclosure uses a local management device to receive the logistics data from end devices. The local management device also checks and structures the logistics data. The local management device combines the structured logistics data into a data group, and transmits the data group to the central server. Accordingly, the logistics data from end devices can be pre-processed at the local management device; and the processing loading of the central server can be reduced. Therefore, the efficiency of logistics data transmission can be improved. Additionally, the logistics data transmitting system can be easily expanded by adding new local management devices as a sub-system. Therefore, the logistics data transmitting system allows a logistics service provider to arrange the architecture of the logistics system for different requirements. A new local management can be added to the system as a sub-system without changing the original architecture. Also, the logistics data transmitting system of the present disclosure structures raw logistics data to form a structured data group to solve the discontinuity problem of data from different end devices at different time, and hence improves the readability of the logistics data.

The embodiments shown and described above are only examples. Many details are often found in the art such as the other features of a logistics data transmitting system and method thereof. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A logistics data transmitting system for receiving and transmitting logistics data, comprising at least on end device, a local management device, and a central server; wherein:
the at least one end device receives the logistics data and transmits the logistics data to the local management device;
the local management device processes the logistics data transmitted from the end device and transmits the processed logistics data to the central server; and
the local management device comprises:
a collecting unit for determining whether the logistics data satisfies a checking rule;
a combining unit for structuring the logistics data and combining the structured logistics data to form a data group; and
a processed data storage unit for storing the data group.

2. The logistics data transmitting system of claim 1, wherein the logistics data is arranged in order and classified by the collecting unit.

3. The logistics data transmitting system of claim 1, wherein the local management device further comprises an illegal data section for storing logistics data that does not satisfy the checking rule.

4. The logistics data transmitting system of claim 1, wherein the local management device transmits the data group to the central server.

5. The logistics data transmitting system of claim 4, wherein the central server comprises a verification module for verifying the data group.

6. The logistics data transmitting system of claim 4, wherein the central server comprises a discrete module for discretizing the data group.

7. A logistics data transmitting method for a logistics data transmitting system; wherein the logistics data transmitting system comprises at least one end device, a local management device and a central server; the local management device comprises a collecting unit, a combining unit, and a processed data storage unit; and the logistics data transmitting method comprises steps of:
the local management device receiving logistics data from the end device;
the collecting unit determining whether the logistics data satisfies a checking rule;
the combining unit structuring the logistics data and storing the structured logistics data in the processed data storage unit;
determining whether the logistics data in the processed data storage unit exceeds a predetermined quantity;
when the logistics data in the processed data storage unit exceeds the predetermined quantity, combining the logistics data in the processed data storage unit to form a data group; and
transmitting the data group to the central server.

8. The logistics data transmitting method of claim 7, wherein the central server comprises a verification module; and the logistics data transmitting method further comprises:
the verification module determining whether the data group is verified.

9. The logistics data transmitting method of claim 7, wherein the central server comprises a discrete module; and the data logistics data transmitting method further comprises:
the discrete module discretizing the data group and causing the discretized data group to be stored in the central server.

10. The logistics data transmitting method of claim 7, wherein in the step of structuring the logistics data, the logistics data transmitting method further comprises:
the combining unit determining whether the structured logistics data is correct.
